(19) United States
(12) Patent Application Publication
(10) Pub. No.: US 2020/0180638 A1
(43) Pub. Date: Jun. 11, 2020

(54) VEHICLE CONTROL SYSTEM AND VEHICLE CONTROL METHOD

(71) Applicant: HONDA MOTOR CO., LTD., Minato-ku, Tokyo (JP)

(72) Inventor: Tadahiko Kanoh, Wako-shi (JP)

(21) Appl. No.: 16/614,460

(22) PCT Filed: May 26, 2017
(86) PCT No.: PCT/JP2017/019686

§ 371 Date: Nov. 18, 2019

(51) Int. Cl. B60W 30/18; G08G 1/16

(52) U.S. Cl. CPC B60W 30/18163; B60W 2554/00; G08G 1/16

(57) ABSTRACT

A vehicle control system includes a detector configured to detect an object present in a detection area, a travel controller configured to perform travel control for a host vehicle on the basis of a detection result of the detector, and a determiner configured to determine whether or not the object detected by the detector is present in a blind spot area, the blind spot area being outside the detection area of the detector, and the travel controller is configured to perform control for changing a relative position of the host vehicle with respect to the object in the blind spot area when the determiner has determined that the object is present in the blind spot area.

### TECHNICAL FIELD

The present invention relates to a vehicle control system and a vehicle control method.

### BACKGROUND ART

In the related art, a technology for determining whether or not an object has entered a blind spot area of an adjacent lane and prohibiting assistance control for automatically changing lanes when it is determined that an object has entered a blind spot area is known (see Patent Document 1, for example).

### PRIOR ART DOCUMENTS

### Patent Documents

### [Patent Document 1]

Japanese Unexamined Patent Application, First Publication No. 2016-224785

### SUMMARY OF INVENTION

### Problems to be Solved by the Invention

However, in the related art, since there is no solution to a state in which an object has entered a blind spot area, various vehicle controls as well as the lane change may be limited.

The present invention has been made in consideration of such circumstances, and an object of the present invention is to provide a vehicle control system and a vehicle control method capable of improving a degree of freedom of vehicle control by enhancing object detection performance

### Solution to Problem

(1) A vehicle control system including: a detector configured to detect an object present in a detection area; a travel controller configured to perform travel control for a host vehicle on the basis of a detection result of the detector; and a determiner configured to determine whether or not the object detected by the detector is present in a blind spot area, the blind spot area being outside the detection area of the detector, wherein the travel controller is configured to perform control for changing a relative position of the host vehicle with respect to the object in the blind spot area when the determiner has determined that the object is present in the blind spot area.

(2) In the vehicle control system according to (1), the travel controller is configured to perform control for changing the relative position of the host vehicle with respect to the object in the blind spot area through speed control when the determiner has determined that the object is present in the blind spot area.

(3) In the vehicle control system according to (1) or (2), the blind spot area is present on the side of the host vehicle, and the travel controller is configured to change the relative position of the host vehicle with respect to the object in the blind spot area according to a width of the blind spot area in a traveling direction of the host vehicle.

(4) The vehicle control system according to any one of (1) to (3) further includes: a lane change controller configured to automatically perform lane change from a host lane to an adjacent lane, wherein the lane change controller is configured to determine whether or not the host vehicle is capable of lane change from the host lane to the adjacent lane after the travel controller has changed the relative position of the host vehicle with respect to the object in the blind spot area in a case in which a starting condition of the lane change has been satisfied and the determiner has determined that the object is present in the blind spot area.

(5) In the vehicle control system according to (4), when the determiner has determined that the object is present in the blind spot area and the starting condition of lane change in the lane change controller has been satisfied, the travel controller is configured to perform control for changing the relative position of the host vehicle with respect to the object in the blind spot area through speed control.

(6) The vehicle control system according to any one of (1) to (5) further includes a lane change controller configured to automatically perform lane change from a host lane to an adjacent lane, wherein the determiner is configured to determine whether or not the object detected by the detector is present in the blind spot area when the starting condition of lane change in the lane change controller has been satisfied.

(7) The vehicle control system according to (6) further includes: a route determiner configured to determine a route for travel of the vehicle, wherein the starting condition of lane change includes lane change from the host lane to the adjacent lane being scheduled in the route determined by the route determiner.

(8) In the vehicle control system according to any one of (1) to (7), the determiner is configured to determine that an object is present in the blind spot area when the object temporarily detected by the detector is not continuously detected over a predetermined time or more.

(9) A vehicle control system including: a detector configured to detect an object present in a detection area; a generator configured to generate an action plan for the host vehicle; a travel controller configured to perform travel control of the host vehicle on the basis of a detection result of the detector and the action plan generated by the generator; and a determiner configured to determine whether or not the object detected by the detector is present in a blind spot area, the blind spot area being outside the detection area of the detector, wherein the generator is configured to generate, as the action plan, a plan for changing a relative position of the host vehicle with respect to the object in the blind spot area when the determiner has determined that the object is present in the blind spot area.

(10) A vehicle control system including: a detector configured to detect an object present in a detection area; a travel controller configured to perform travel control for a host vehicle on the basis of a detection result of the detector; and a determiner configured to determine whether or not the object detected by the detector is present in a blind spot area, the blind spot area being outside the detection area of the detector, wherein the travel controller is configured to perform control for changing a relative position of the host vehicle with respect to the object in the blind spot area when the object is not detected in the detection area of the detector within a predetermined time after the determiner is configured to determine that the object is present in the blind spot area.

(11) A vehicle control method including: detecting, by an in-vehicle computer, an object present in a detection area; performing, by the in-vehicle computer, travel control for a host vehicle on the basis of a detection result for the object; determining, by the in-vehicle computer, whether or not the detected object is present in a blind spot area, the blind spot area being outside the detection area; and performing, by the in-vehicle computer, control for changing a relative position of the host vehicle with respect to the object in the blind spot area when it is determined that the object is present in the blind spot area.

(12) The vehicle control method according to (11) includes automatically performing, by the in-vehicle computer, lane change from a host lane to an adjacent lane; and determining, by the in-vehicle computer, whether or not the detected object is present in the blind spot area when a starting condition of the lane change has been satisfied.

(13) A vehicle control method including: detecting, by an in-vehicle computer, an object present in a detection area; performing, by the in-vehicle computer, travel control for a host vehicle on the basis of a detection result for the object; determining, by the in-vehicle computer, whether or not the detected object is present in a blind spot area, the blind spot area being outside the detection area; and performing, by the in-vehicle computer, control for changing a relative position of the host vehicle with respect to the object in the blind spot area when the object is not detected in the detection area within a predetermined time after it is determined that the object is present in the blind spot area.

### Advantageous Effects of Invention

According to any of (1) to (13), it is possible to improve a degree of freedom in vehicle control by performing control for changing the relative position of the host vehicle with respect to the object in the blind spot area to enhance object detection performance when it is determined that the object is present in the blind spot area of the detector.

### BRIEF DESCRIPTION OF THE DRAWINGS

FIG. 1 is a diagram showing a configuration of a vehicle in which a vehicle control system 1 is mounted in a first embodiment.

FIG. 2 is a diagram schematically showing detection areas of a radar 12 and a finder 14.

FIG. 3 is a configuration diagram of the vehicle control system 1 including an automated driving controller 100 of the first embodiment.

FIG. 4 is a diagram showing a state in which a host vehicle position recognizer 122 recognizes a relative position and posture of a host vehicle M with respect to a travel lane L1.

FIG. 5 is a diagram showing a state in which a target trajectory is generated on the basis of a recommended lane.

FIG. 6 is a flowchart showing an example of a series of processes of an object recognition device 16 and an automated driving controller 100 in the first embodiment.

FIG. 7 is a diagram schematically showing a state in which an object OB is lost during tracking.

FIG. 8 is a diagram schematically showing a state in which a relative position of the host vehicle M with respect to the object OB present in a blind spot area BA is changed.

FIG. 9 is a flowchart showing another example of a series of processes of the object recognition device 16 and the automated driving controller 100 in the first embodiment.

FIG. 10 is a flowchart showing an example of a series of processes of the object recognition device 16 and the automated driving controller 100 in a second embodiment.

FIG. 11 is a configuration diagram of a vehicle control system 2 of a third embodiment.

### DESCRIPTION OF EMBODIMENTS

Hereinafter, embodiments of a vehicle control system and a vehicle control method of the present invention will be described with reference to the drawings.

### First Embodiment

### [Vehicle Configuration]

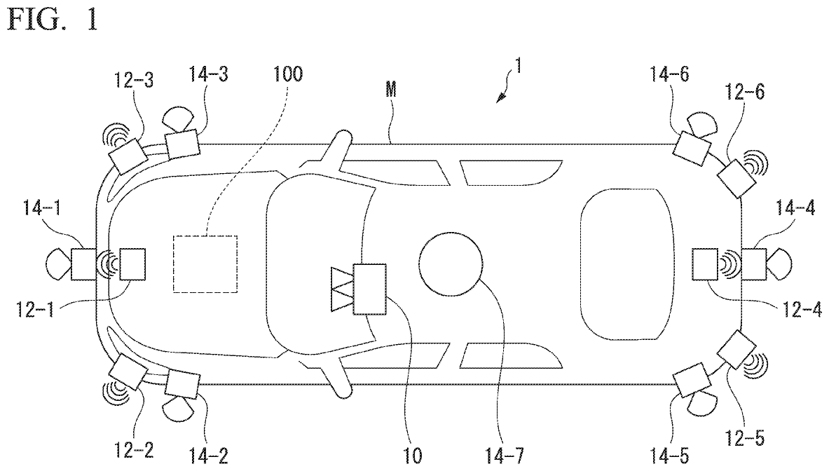

FIG. 1 is a diagram showing a configuration of a vehicle (hereinafter referred to as a host vehicle M) in which a vehicle control system 1 is mounted in the first embodiment. The host vehicle M is, for example, a vehicle such as a two-wheeled vehicle, a three-wheeled vehicle, or a four-wheeled vehicle. A driving source thereof is an internal combustion engine such as a diesel engine or a gasoline engine, an electric motor, or a combination thereof. The electric motor operates using power generated by a power generator connected to the internal combustion engine or discharge power of a secondary battery or a fuel cell.

As shown in FIG. 1, the host vehicle M includes, for example, sensors such as a camera 10, radars 12-1 to 12-6, and finders 14-1 to 14-7, and an automated driving controller 100 to be described below.

For example, in the case of forward imaging, the camera 10 is attached to an upper portion of a front windshield, a rear surface of a rearview mirror, or the like in a vehicle cabin. Further, for example, the radar 12-1 and the finder 14-1 are installed in a front grill, a front bumper, or the like, and the radars 12-2 and 12-3 and the finders 14-2 and 14-3 are installed inside a door mirror or a headlamp, near a side light on the front end side of the vehicle, or the like. Further, for example, the radar 12-4 and the finder 14-4 are installed in a trunk lid or the like, and the radars 12-5 and 12-6 and the finders 14-5 and 14-6 are installed inside a taillight, near a side light on the rear end side of the vehicle, or the like. Further, for example, the finder 14-7 is installed in a bonnet, a roof, or the like. In the following description, particularly, the radar 12-1 is referred to as a “front radar”, the radars 12-2, 12-3, 12-5, and 12-6 are referred to as “corner radars”, and the radar 12-4 is referred to as a “rear radar”. Further, when the radars 12-1 to 12-6 are not particularly distinguished, the radars 12-1 to 12-6 are simply referred to as a “radar 12”, and when the finders 14-1 to 14-7 are not particularly distinguished, the finders 14-1 to 14-7 are simply referred to as a “finder 14”.

The camera 10 is, for example, a digital camera using a solid-state imaging device such as a charge coupled device (CCD) or a complementary metal oxide semiconductor (CMOS). The camera 10, for example, periodically and repeatedly images surroundings of the host vehicle M. The camera 10 may be a stereo camera.

The radar 12 radiates radio waves such as millimeter waves to the surroundings of the host vehicle M and detects radio waves (reflected waves) reflected by an object to detect at least a position (a distance and orientation) of the object. The radar 12 may detect a position and a speed of the object using a frequency modulated continuous wave (FM-CW) scheme.

The finder 14 is Light Detection and Ranging or Laser Imaging Detection and Ranging (LIDAR) that measures scattered light with respect to irradiation light and detects a distance to a target.

The configuration shown in FIG. 1 is merely an example, and a part of the configuration may be omitted, or another configuration may be added.

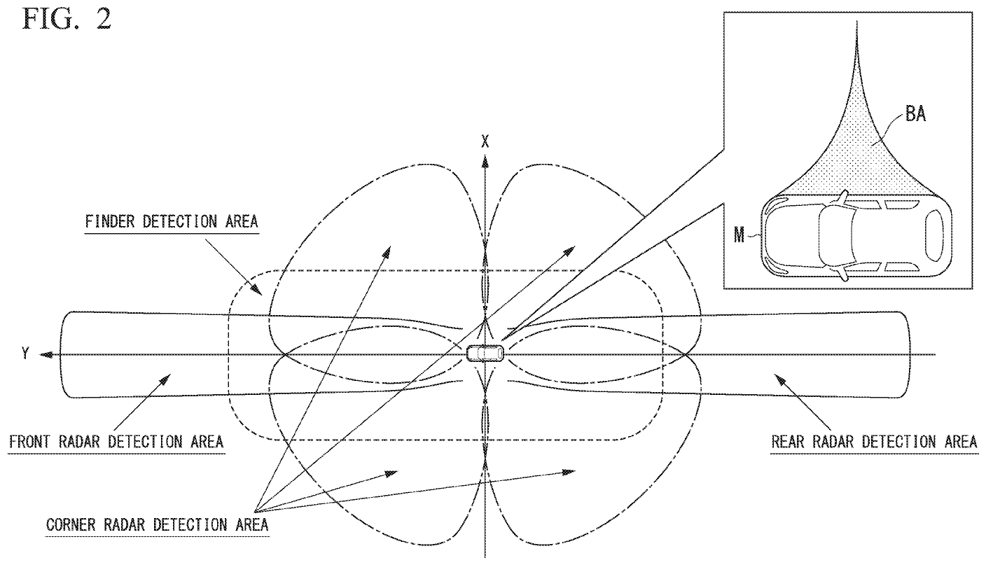

FIG. 2 is a diagram schematically showing detection areas of the radar 12 and the finder 14. As shown in FIG. 2, when the host vehicle M is viewed from above, the front radar and the rear radar have, for example, a detection area wider in a depth direction (a distance direction) indicated by a Y axis in FIG. 2 than in an azimuth direction (a width direction) indicated by an X axis in FIG. 2. Further, each corner radar has, for example, a detection area that is narrower than the detection area in the depth direction in the front radar and the rear radar, and wider than the detection area in the azimuth direction. Further, for example, the finders 14-1 to 14-6 have a detection area of about 150 degrees with respect to a horizontal direction, and the finder 14-7 has a detection area of 360 degrees with respect to the horizontal direction. Thus, since the radar 12 and the finder 14 are installed at intervals around the host vehicle M, and the radar 12 and the finder 14 have the detection areas corresponding to a predetermined angle, a blind spot area BA is formed in an area near the host vehicle M. As shown in FIG. 2, for example, an area that does not overlap any of the detection areas of the two corner radars installed on the same vehicle side surface is formed as the blind spot area BA. Since the respective corner radars are installed on the front end side and the rear end side on the same side surface of the host vehicle M, the blind spot area BA becomes a finite area at least in a vehicle traveling direction (a Y-axis direction in FIG. 2). Hereinafter, description will be given on the basis of this premise. A directional angle (an angle width with respect to the horizontal direction) or a directional direction (radiation directivity) of the detection area of the radar 12 and the finder 14 may be changeable electrically or mechanically. Further, when a plurality of areas that do not overlap any detection area in a direction away from the host vehicle M, which is a starting point, in an X-Y plane (a horizontal plane) when the host vehicle M is viewed from above are formed, the area closest to the host vehicle M may be treated as the blind spot area BA.

### [Configuration of Vehicle Control System]

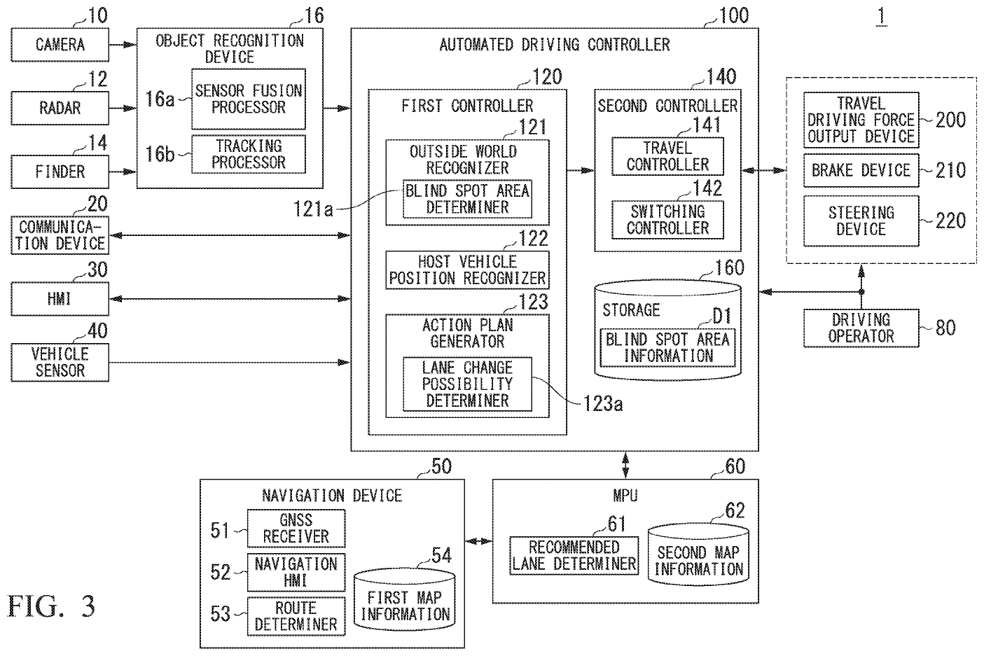

FIG. 3 is a configuration diagram of the vehicle control system 1 including the automated driving controller 100 of the first embodiment. The vehicle control system 1 of the first embodiment includes, for example, a camera 10, a radar 12, a finder 14, an object recognition device 16, a communication device 20, a human machine interface (HMI) 30, a vehicle sensor 40, a navigation device 50, a map position unit (MPU) 60, a driving operator 80, the automated driving controller 100, a travel driving force output device 200, a brake device 210, and a steering device 220. These devices or equipment are connected to each other by a multiplex communication line such as a controller area network (CAN) communication line, a serial communication line, a wireless communication network, or the like. The configuration shown in FIG. 3 is merely an example, and a part of the configuration may be ommitted or another configuration may be added.

The object recognition device 16 includes, for example, a sensor fusion processor 16a and a tracking processor 16b. Some or all of components of the object recognition device 16 are realized by a processor such as a central processing unit (CPU) executing a program (software). Further, some or all of components of the object recognition device 16 may be realized by hardware such as a large scale integration (LSI), an application specific integrated circuit (ASIC), or a field-programmable gate array (FPGA) or may be realized by the software and the hardware in cooperation. A combination of the camera 10, the radar 12, the finder 14, and the object recognition device 16 is an example of a “detector”.

The sensor fusion processor 16a performs a sensor fusion process on detection results of some or all of the camera 10, the radar 12, and the finder 14 to recognize a position, type, speed, movement direction, and the like of an object OB. The object OB is, for example, a vehicle (a vehicle such as a two-wheeled, three-wheeled, or four-wheeled vehicle) around the host vehicle M, or objects of types such as a guardrail, a utility pole, and a pedestrian. The position of the object OB recognized through the sensor fusion process is represented, for example, by coordinates in a virtual space corresponding to a real space in which the host vehicle M is present (for example, a virtual three-dimensional space having dimensions (bases) corresponding to height, width, and depth).

The sensor fusion processor 16a repeatedly acquires information indicating a detection result from each sensor at the same cycles as a detection cycle of each sensor of the camera 10, the radar 12, and the finder 14 or at cycles longer than the detection cycle, and recognizes the position, type, speed, movement direction, or the like of the object OB each time the sensor fusion processor 16a acquires the information. The sensor fusion processor 16a outputs a result of the recognition of the object OB to the automated driving controller 100.

The tracking processor 16b determines whether or not the objects OB recognized at different timings by the sensor fusion processor 16a are the same object, and associates, for example, positions, speeds, and movement directions of the objects OB with each other when the objects OB are the same object, thereby tracking the object OB.

For example, the tracking processor 16b compares a feature amount of an object OBᵢ recognized at certain time t, in the past by the sensor fusion processor 16a with a feature amount of an object OBᵢ₊, recognized at time tᵢ₊₁ after time tᵢ. When the feature amounts match at a certain degree, the tracking processor 16b determines that the object OBᵢ recognized at time t, and the object OBᵢ₊₁ recognized at time tᵢ₊₁ are the same object. The feature amount is, for example, a position, speed, shape, or size in a virtual three-dimensional space. The tracking processor 16b associates the feature amounts of the objects OB determined to be the same with each other, thereby tracking objects of which recognition timings are different, as the same objects.

The tracking processor 16b outputs information indicating the recognition result (position, type, speed, movement direction, or the like) for the tracked object OB to the automated driving controller 100. Further, the tracking processor 16b may output information indicating a recognition result for the object OB that has not been tracked, that is, information indicating a simple recognition result of the sensor fusion processor 16a to the automated driving controller 100. Further, the tracking processor 16b may output a part of information input from the camera 10, the radar 12, or the finder 14 to the automated driving controller 100 as it is.

The communication device 20, for example, communicates with another vehicle around the host vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the host vehicle M and receives an input operation of the occupant. The HMI 30 includes various display devices such as a liquid crystal display (LCD) or an organic electroluminescence (EL) display, various buttons, a speaker, a buzzer, a touch panel, and the like.

The vehicle sensor 40 includes, for example, a vehicle speed sensor that detects a speed of the host vehicle M, an acceleration sensor that detects an acceleration, a yaw rate sensor that detects an angular speed around a vertical axis, and an orientation sensor that detects a direction of the host vehicle M.

The navigation device 50 includes, for example, a global navigation satellite system (GNSS) receiver 51, a navigation HMI 52, and a route determiner 53, and holds first map information 54 in a storage device such as a hard disk drive (HDD) or a flash memory. The GNSS receiver 51 specifies a position of the host vehicle M on the basis of a signal received from a GNSS satellite. The position of the host vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determiner 53, for example, determines a route from the position of the host vehicle M (or any input position) specified by the GNSS receiver 51 to a destination input by the occupant using the navigation HMI 52 by referring to the first map information 54.

The first map information 54 is, for example, information in which a road shape is represented by links indicating roads and nodes connected by the links. The first map information 54 may include a curvature of the road, point of interest (POI) information, and the like. The route determined by the route determiner 53 is output to the MPU 60. Further, the navigation device 50 may perform route guidance using the navigation HMI 52 on the basis of the route determined by the route determiner 53. The navigation device 50 may be realized, for example, by a function of a terminal device such as a smartphone or a tablet terminal possessed by the occupant. Further, the navigation device 50 may transmit a current position and a destination to a navigation server via the communication device 20 and acquire a route that is replied from the navigation server.

The MPU 60 functions, for example, as a recommended lane determiner 61 and holds second map information 62 in a storage device such as an HDD or a flash memory. The recommended lane determiner 61 divides the route provided from the navigation device 50 into a plurality of blocks (for example, divides the route every 100 [m] in the traveling direction of the vehicle) and determines a recommended lane for each block by referring to the second map information 62. The recommended lane determiner 61 performs a process of determining which lane from the left to be the recommended lane. The recommended lane determiner 61 determines the recommended lane so that the host vehicle M can travel on a reasonable route for traveling to a branch destination when there is a branch place or a merging place in the route.

The second map information 62 is map information with higher accuracy than the first map information 54. The second map information 62 includes, for example, information on a center of the lane or information on a boundary of the lane. Further, the second map information 62 may include road information, traffic regulation information, address information (an address and postal code), facility information, telephone number information, and the like. The road information includes information indicating types of roads such as expressways, toll roads, national expressways, and prefectural roads, or information such as a reference speed of the road, the number of lanes, a width of each lane, a gradient of road, a position (three-dimensional coordinates including longitude, latitude, and height) of the road, a curvature of curves of the road or each lane of the road, positions of merging and branching points of a lane, and signs provided on the road. The reference speed is, for example, a legal speed or an average speed of a plurality of vehicles that have traveled the road in the past. The second map information 62 may be updated at any time through access to another device using the communication device 20.

The driving operator 80 includes, for example, an accelerator pedal, a brake pedal, a shift lever, a steering wheel, a winker lever, and other operators. An operation detector that detects an amount of operation is attached to the driving operator 80. The operation detector detects an amount of depression of the accelerator pedal or the brake pedal, a position of the shift lever, a steering angle of the steering wheel, a position of the winker lever, and the like. The operation detector outputs a detection signal indicating the detected amount of operation of each operator to the automated driving controller 100, or one or both of the travel driving force output device 200, the brake device 210, and the steering device 220.

The automated driving controller 100 includes, for example, a first controller 120, a second controller 140, and a storage 160. Some or all of components of the first controller 120 and the second controller 140 are realized by a processor such as a CPU executing a program (software). Further, some or all of the components of the first controller 120 and the second controller 140 may be realized by hardware such as LSI, ASIC, or FPGA or may be realized by software and hardware in cooperation.

The storage 160 is realized by a storage device such as an HDD, a flash memory, a random access memory (RAM), and a read only memory (ROM). In the storage 160, programs referred to by the processor are stored, and blind spot area information D1 and the like are stored. The blind spot area information D1 is information on the blind spot area BA obtained from, for example, disposition positions of the camera 10, the radar 12, and the finder 14. For example, the blind spot area information D1 indicates information in which a position at which the blind spot area BA is present with respect to the host vehicle M has been represented by coordinates in the virtual three-dimensional space described above when a certain reference position of the host vehicle M is set as origin coordinates. Content of the blind spot area information D1 may be changed by calculation being performed to determine a shape of the blind spot area BA and a position at which the blind spot area BA is present each time, for example, the directional angle of the detection area of the radar 12 or the finder 14 has been changed when the directional angle has been changed.

The first controller 120 includes, for example, an outside world recognizer 121, a host vehicle position recognizer 122, and an action plan generator 123.

The outside world recognizer 121, for example, recognizes a state such as a position, a speed, or acceleration of the object OB on the basis of the information input from the camera 10, the radar 12, and the finder 14 via the object recognition device 16. The position of the object OB may be represented by a representative point such as a centroid or a corner of the object OB or may be represented by an area represented by an outline of the object OB. The “state” of the object OB may include an acceleration, a jerk, or the like of the object OB. Further, when the object OB is a nearby vehicle, the “state” of the object OB may include, for example, an action state such as whether or not the nearby vehicle is changing lanes or the nearby vehicle is about to change lanes.

Further, the outside world recognizer 121 has a function of determining whether or not there is the object OB in the blind spot area BA, in addition to the above-described function. Hereinafter, this function will be described as a blind spot area determiner 121a.

For example, the blind spot area determiner 121a determines whether or not the object OB tracked by the tracking processor 16b of the object recognition device 16 has entered the blind spot area BA by referring to the blind spot area information D1 stored in the storage 160. This determination process will be described in detail in a process of a flowchart to be described below. The blind spot area determiner 121a outputs information indicating a determination result to the second controller 140.

The host vehicle position recognizer 122 recognizes, for example, a lane (a traveling lane) on which the host vehicle M is traveling and a relative position and posture of the host vehicle M with respect to the traveling lane. The host vehicle position recognizer 122, for example, compares a pattern of a road lane marker (for example, an arrangement of solid lines and broken lines) obtained from the second map information 62 with a pattern of the road lane maker around the host vehicle M recognized from the image captured by the camera 10 to recognize the traveling lane. In this recognition, the position of the host vehicle M acquired from the navigation device 50 or a processing result of INS may be taken into account. The host vehicle position recognizer 122 recognizes, for example, the position or posture of the host vehicle M with respect to the traveling lane.

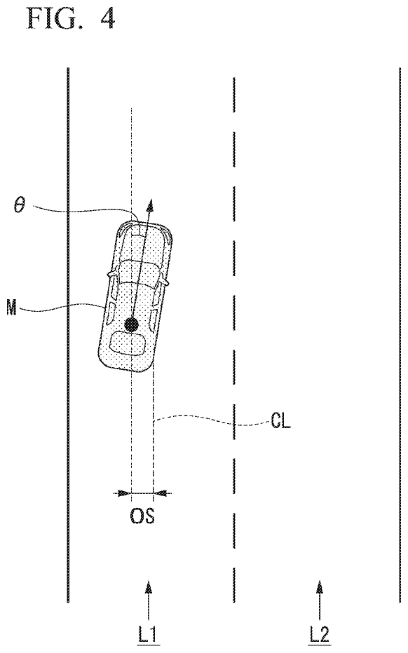

FIG. 4 is a diagram showing a state in which the host vehicle position recognizer 122 recognizes the relative position and posture of the host vehicle M with respect to the travel lane L1. The host vehicle position recognizer 122, for example, recognizes a deviation OS of a reference point (for example, a centroid) of the host vehicle M from a traveling lane center CL and an angle θ of a travel direction of the host vehicle M with respect to a line connecting the traveling lane centers CL as the relative position and the posture of the host vehicle M with respect to the traveling lane L1. Alternatively, the host vehicle position recognizer 122 may recognize, for example, a position of the reference point of the host vehicle M relative to any one of side end portions of the traveling lane L1 as the relative position of the host vehicle M with respect to the traveling lane. The relative position of the host vehicle M recognized by the host vehicle position recognizer 122 is provided to the recommended lane determiner 61 and the action plan generator 123.

The action plan generator 123 determines events to be sequentially executed in the automated driving so that the host vehicle M travels along the recommended lane determined by the recommended lane determiner 61 and so that the host vehicle M can cope with a situation of surroundings of the host vehicle M. The events include, for example, a constant-speed traveling event in which a vehicle travels on the same traveling lane at a constant speed, a lane changing event in which a traveling lane of the host vehicle M is changed, an overtaking event in which the host vehicle M overtakes a preceding vehicle, a following traveling event in which the host vehicle M travels following a preceding vehicle, a merging event in which the host vehicle M is caused to merge at a merging point, a branching event in which the host vehicle M is caused to travel on a target lane at a branching point of a road, an emergency stopping event in which the host vehicle M is caused to make an emergency stop, and a switching event in which automated driving is ended and switching to manual driving is performed. An action for avoidance may also be planned on the basis of the situation of the surroundings of the host vehicle M (presence of nearby vehicles or pedestrians, lane narrowing due to road construction, or the like) during execution of these events.

The action plan generator 123 generates a target trajectory when the host vehicle M will be caused to travel on the route determined by the route determiner 53 in the future, on the basis of the determined events (a set of a plurality of events planned according to the route). The target trajectory is represented by arranging points (trajectory points) that the host vehicle M will reach in an order. The trajectory point is a point that the host vehicle M will reach at each predetermined travel distance. Separately, a target speed at each predetermined period of sampling time (for example, several tenths of a [sec]) is determined as a part (one element) of the target trajectory. The target speed may include an element such as a target acceleration or a target jerk. Further, the trajectory point may be a position that the host vehicle M will reach at a sampling time in the predetermined period of sampling time. In this case, the target speed is determined using an interval between the trajectory points.

For example, the action plan generator 123 determine the target speed when the host vehicle M is caused to travel along the target trajectory, on the basis of a reference speed set on the route to the destination in advance or a relative speed with respect to the object OB such as a nearby vehicle at the time of traveling. Further, the action plan generator 123 determines a target rudder angle (for example, a target steering angle) when the host vehicle M is caused to travel along the target trajectory, on the basis of a positional relationship between the trajectory points. The action plan generator 123 outputs the target trajectory including the target speed and the target rudder angle as elements to the second controller 140.

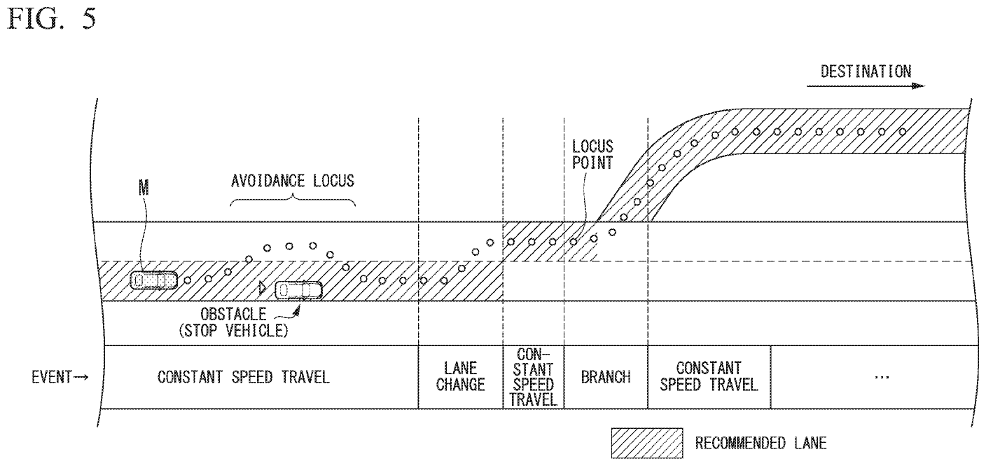

FIG. 5 is a diagram showing a state in which the target trajectory is generated on the basis of the recommended lane. As shown in FIG. 5, the recommended lane is set so that the recommended lane makes it convenient to travel along the route to the destination. The action plan generator 123 activates a lane changing event, a branching event, a merging event, or the like when the host vehicle approaches a predetermined distance before a switching point of the recommended lane (which may be determined according to a type of event). When it becomes necessary to avoid an obstacle OB during execution of each event, an avoidance trajectory is generated as shown in FIG. 5.

The action plan generator 123, for example, generates a plurality of candidates of the target trajectory while changing the positions of the trajectory points so that the target rudder angle is changed, and selects an optimal target trajectory at that point in time. The optimal target trajectory may be, for example, a trajectory on which an acceleration in a vehicle width direction to be applied to the host vehicle M is equal to or lower than a threshold value when steering control has been performed according to the target rudder angle applied by the target trajectory or may be a trajectory on which the host vehicle M can reach a destination earliest when speed control has been performed according to the target speed indicated by the target trajectory.

In addition to the various functions described above, the action plan generator 123 has a function of determining whether or not a starting condition of lane change has been satisfied, to determine whether or not the lane change is executable. In the following description, this function is referred to as a lane change possibility determiner 123a.

For example, when an event with lane change such as the lane changing event, the overtaking event, or the branching event on the route for which the recommended lane has been determined (the route determined by the route determiner 53) has been planned, when the host vehicle M reaches at a point at which the event has been planned, or when the host vehicle M has reached at the point, the lane change possibility determiner 123a determines that the starting condition of lane change has been satisfied.

Further, when the operation detector of the driving operator 80 has detected that the position of the winker lever has been changed (when the winker lever has been operated), that is, when the lane change has been instructed according to an intention of the occupant, the lane change possibility determiner 123a determines that the starting condition of lane change has been satisfied.

The lane change possibility determiner 123a determines whether or not a lane change execution condition is satisfied when the starting condition of lane change has been satisfied, determines that the lane change is possible when the lane change execution condition is satisfied, and determines that the lane change is not possible when the lane change execution condition is not satisfied. The lane change execution condition will be described below. The lane change possibility determiner 123a outputs to the second controller 140 information indicating a result of the determination as to whether the starting condition of lane change has been satisfied or a result of the determination as to whether the lane change is executable.

Further, when the blind spot area determiner 121a has determined that the object OB is present in the blind spot area BA and the lane change possibility determiner 123a has determined that the starting condition of lane change has been satisfied, the action plan generator 123 newly generates a target trajectory for changing the relative position of the host vehicle M with respect to the object OB present in the blind spot area BA.

The second controller 140 includes, for example, a travel controller 141 and a switching controller 142. A combination of the action plan generator 123, the lane change possibility determiner 123a, and the travel controller 141 is an example of a “lane change controller”.

The travel controller 141 performs at least one of speed control and steering control of the host vehicle M so that the host vehicle M passes through the target trajectory generated by the action plan generator 123 at a scheduled time. For example, the travel controller 141 controls the travel driving force output device 200 and the brake device 210 to perform the speed control, and controls the steering device 220 to perform the steering control. The speed control and the steering control are examples of “travel control”.

The travel driving force output device 200 outputs a travel driving force (torque) for traveling of the vehicle to the driving wheels. The travel driving force output device 200 includes, for example, a combination with an internal combustion engine, an electric motor, a transmission, and the like, and an electronic control unit (ECU) that controls these. The ECU controls the above configuration according to information input from the travel controller 141 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the travel controller 141 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the travel controller 141 and transfers the hydraulic pressure of the master cylinder to the cylinder.

The steering device 220 includes, for example, a steering ECU and an electric motor. The electric motor, for example, changes a direction of steerable wheels by causing a force to act on a rack and pinion mechanism. The steering ECU drives the electric motor according to information input from the travel controller 141 or information input from the driving operator 80 to change the direction of the steerable wheels.

For example, the travel controller 141 determines the amounts of control of the travel driving force output device 200 and the brake device 210 according to the target speed indicated by the target trajectory.

Further, the travel controller 141 determines, for example, the amount of control of the electric motor in the steering device 220 so that a displacement corresponding to the target rudder angle indicated by the target trajectory is applied to the wheels.

The switching controller 142 switches between driving modes of the host vehicle M on the basis of an action plan generated by the action plan generator 123. The driving mode includes an automated driving mode in which the travel driving force output device 200, the brake device 210, and the steering device 220 are controlled according to the control of the second controller 140, and a manual operation mode in which the travel driving force output device 200, the brake device 210, and the steering device 220 are controlled according to an operation of the occupant with respect to the driving operator 80.

For example, the switching controller 142 switches the driving mode from the manual driving mode to the automated driving mode at a scheduled start point of the automated driving. Further, the switching controller 142 switches the driving mode from the automated driving mode to the manual driving mode at a scheduled end point of automated driving (for example, a destination).

Further, the switching controller 142, for example, may switch between the automated driving mode and the manual operation mode according to an operation with respect to, for example, a switch included in the HMI 30.

Further, the switching controller 142 may switch the driving mode from the automated driving mode to the manual driving mode on the basis of the detection signal input from the driving operator 80. For example, when the amount of operation indicated by the detection signal exceeds a threshold value, that is, when the driving operator 80 receives an operation from the occupant with an amount of operation exceeding the threshold value, the switching controller 142 switches the driving mode from the automated driving mode to the manual driving mode. For example, in a case in which the driving mode is set to the automated driving mode and a case in which the steering wheel and the accelerator pedal or the brake pedal are operated by the occupant with an amount of operation exceeding the threshold value, the switching controller 142 switches the driving mode from the automated driving mode to the manual driving mode.

In the manual driving mode, an input signal (a detection signal indicating the degree of amount of operation) from the driving operator 80 is output to the travel driving force output device 200, the brake device 210, and the steering device 220. Further, the input signal from the driving operator 80 may be output to the travel driving force output device 200, the brake device 210, and the steering device 220 via the automated driving controller 100. Each of electronic control units (ECU) of the travel driving force output device 200, the brake device 210, and the steering device 220 performs each operation on the basis of input signals from the driving operator 80 or the like.

### [Processing Flow of Object Recognition Device and Automated Driving Controller]

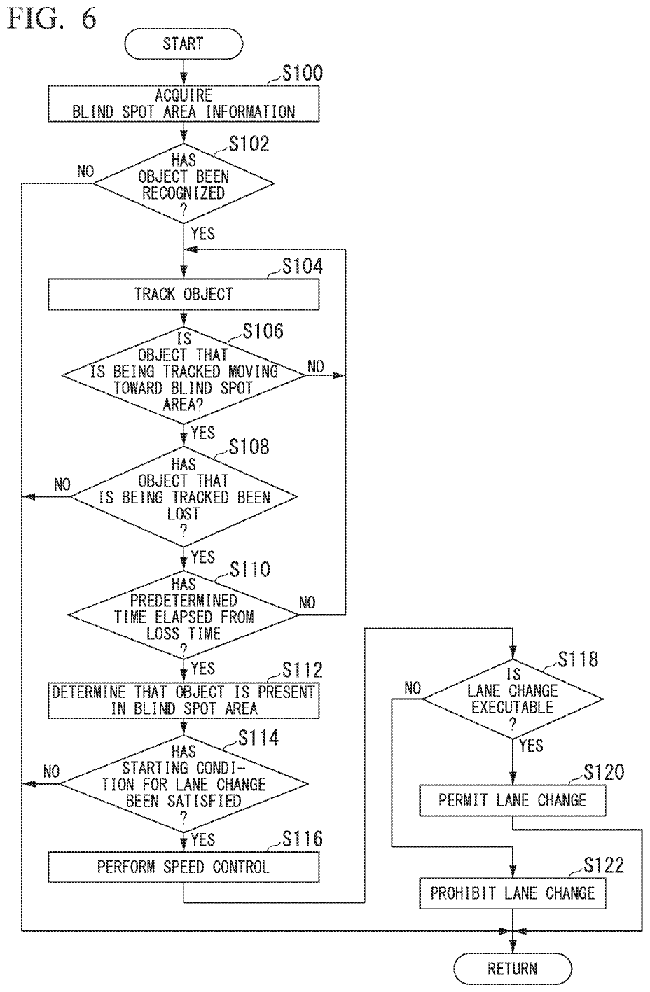

Hereinafter, a series of processes of the object recognition device 16 and the automated driving controller 100 will be described. FIG. 6 is a flowchart showing an example of a series of processes that are performed by the object recognition device 16 and the automated driving controller 100 according to the first embodiment. The process of the flowchart may be performed repeatedly at predetermined time intervals, for example. In addition to the process of the flowchart, it is assumed that the action plan generator 123 determines an event according to a route as an action plan and generates a target trajectory according to the event.

First, the blind spot area determiner 121a acquires the blind spot area information D1 from the storage 160 (step S100). When the directional angle or directional direction (radiation directivity) of the radar 12 and the finder 14 is changed by an actuator (not shown) such as a motor, the blind spot area determiner 121a may calculate an area, shape, or position of the blind spot area BA on the basis of an attachment position of each sensor and a directional angle and a directional direction (radiation directivity) of each sensor.

Then, the tracking processor 16b determines whether or not the object OB has been recognized by the sensor fusion processor 16a (step S102). When the tracking processor 16b determines that the object OB has not been recognized by the sensor fusion processor 16a, the process of the flowchart ends.

On the other hand, when the tracking processor 16b has determined that the object OB has been recognized by the sensor fusion processor 16a, the tracking processor 16b determines whether or not the object is the same as the object OB recognized in the past by the sensor fusion processor 16a, and tracks the object OB when the object is the same as the object OB recognized by the sensor fusion processor 16a (step S104).

Then, the blind spot area determiner 121a determines whether or not the object OB tracked by the tracking processor 16b is moving toward the blind spot area BA by referring to information output by the tracking processor 16b (step S106). For example, the blind spot area determiner 121a determines that the object OB is moving toward the blind spot area BA when the object OB is approaching the host vehicle M (the blind spot area BA) by referring to the position of the object OB sequentially tracked by the tracking processor 16b.

When the blind spot area determiner 121a has determined that the object OB is not moving toward the blind spot area BA, the blind spot area determiner 121a proceeds to S104.

On the other hand, when the blind spot area determiner 121a has determined that the object OB is moving toward the blind spot area BA, the blind spot area determiner 121a determines whether or not the object OB tracked by the tracking processor 16b has been lost (no longer recognized) (step S108).

For example, the tracking processor 16b determines that the object OBᵢ recognized at a current time t, is the same as an object OBᵢ₋₁ recognized at time tᵢ₋₁ before the current time tᵢ, and associates feature amounts of these objects with each other, thereby tracking the object OB at different times (that is, OBᵢ=OBᵢ₋₁). In this case, when the tracking processor 16b has determined that the object OBᵢ at current time tᵢ is different from each object OBᵢ₊₁ recognized at the next time tᵢ₊₁ or when no object OB is recognized at time tᵢ₊₁, the blind spot area determiner 121a determines that the tracked object OB has been lost.

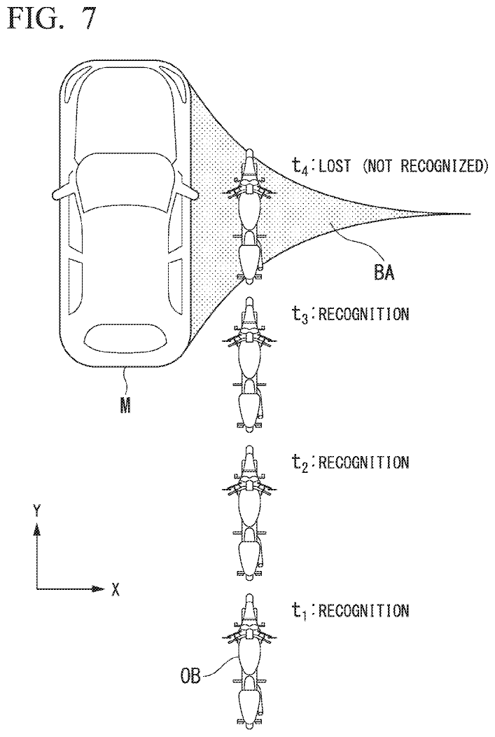

FIG. 7 is a diagram schematically showing a state in which the object OB is lost during tracking. In FIG. 7, t₄ indicates a current time, and t₁ to t₃ indicate past times in a processing cycle. Further, the object OB in FIG. 7 indicates a two-wheeled vehicle.

As shown in FIG. 7, in a situation in which the two-wheeled vehicle is moving from behind the host vehicle M toward the blind spot area BA (a situation in which a speed of the two-wheeled vehicle is higher than a speed of the host vehicle M), the two-wheeled vehicle recognized behind the host vehicle M at time t₁ and tracked at times t₂ and t₃ by the tracking processor 16b, for example, enters the blind spot area BA of the host vehicle M at a certain time (time t₄ in the illustrated example). In this case, the tracking processor 16b loses the tracked two-wheeled vehicle.

In such a case, the blind spot area determiner 121a determines whether or not a predetermined time has elapsed from a loss time tᵢ (the time t₄ in the illustrated example) (step S110). When the predetermined time has not elapsed, the process proceeds to S104 in which the blind spot area determiner 121a determines whether or not an object OB recognized before loss has been recognized again, that is, whether or not tracking has been resumed.

For example, the tracking processor 16b compares each object OB recognized before the predetermined time elapses from the loss time t, with the object OB recognized before loss and determines whether or not these objects, which are comparison targets, are the same object. For example, when a difference in position between the objects OB in a virtual three-dimensional space is equal to or smaller than a reference value, the tracking processor 16b may determine that these objects, which are comparison targets, are the same object. When a difference in speed between the objects OB, that is, a relative speed is equal to or smaller than a reference value, the tracking processor 16b may determine that the objects, which are comparison targets, are the same object. Further, when shapes of the objects OB are similar to each other or have the same size, the tracking processor 16b may determine that the objects, which are comparison targets, are the same object.

The tracking processor 16b stops tracking when the same object as the object OB recognized before loss is not present among a plurality of objects recognized before the predetermined time elapses from the loss time tᵢ. Further, when no object OB is recognized before the predetermined time elapses from the loss time tᵢ, the tracking processor 16b determines that the same object is not present and stops tracking.

When the tracking processor 16b does not resume tracking until the predetermined time elapses from the loss time tᵢ, that is, when the tracking processor 16b has determined that none of objects OB recognized by the sensor fusion processor 16a at certain periodic intervals before the predetermined time elapses is the same as the object OB before loss, the blind spot area determiner 121a determines that the object OB recognized before loss enters the blind spot area BA and is still present in the blind spot area BA at a point in time when the predetermined time has elapsed (step S112). That is, the blind spot area determiner 121a determines that the object OB has entered the blind spot area BA and then is traveling parallel to the host vehicle M in the blind spot area BA. A determination result indicating that the object OB is present in the blind spot area BA means that a likelihood of the object OB being present in the area is high, but the object OB may not be present in practice.

On the other hand, when the tracking processor 16b has resumed tracking before the predetermined time elapses from the loss time tᵢ, the process of the flowchart ends.

Further, when it is determined that no object that is the same as the object OB tracked in the past by the tracking processor 16b is present among the objects OB recognized by the sensor fusion processor 16a before the predetermined time elapses from the loss time tᵢ, the blind spot area determiner 121a determines that the object OB recognized before loss has entered the blind spot area BA and is still present in the blind spot area BA at a point in time when the predetermined time has elapsed.

Then, the lane change possibility determiner 123a of the action plan generator 123 determines whether or not the starting conditions of lane change have been satisfied (step S114). For example, when the event with lane change is scheduled in the action plan and the host vehicle M has reached a point at which the event has been scheduled, the lane change possibility determiner 123a determines that the starting condition of lane change has been satisfied. The lane change possibility determiner 123a may determine that the starting condition of lane change has been satisfied when a winker has been operated by the occupant.

When the lane change possibility determiner 123a has determined that the starting condition of lane change has been satisfied, the action plan generator 123 generates a new target trajectory. For example, the action plan generator 123 again determines a target speed necessary to move the host vehicle M away from the object OB present in the blind spot area BA by at least a maximum width of the blind spot area BA in the traveling direction (a Y-axis direction) of the host vehicle M, and creates the new target trajectory. More specifically, the action plan generator 123 assumes that the object OB present in the blind spot area BA will move at the same speed as a current speed of the host vehicle M in the future, calculates a relative speed of the host vehicle M with respect to the object OB so that the host vehicle M travels over the maximum width of the blind spot area BA during a certain determined time, and determines the target speed again according to the calculated relative speed. When the relative position of the host vehicle M with respect to the object OB in the blind spot area BA has been changed and the blind spot area BA and the object OB are allowed to partially overlap, the action plan generator 123 may generate, for example, a target trajectory with such trends that the acceleration and deceleration increase when the maximum width of the blind spot area BA in the traveling direction of the vehicle increases and the acceleration and deceleration decrease when the maximum width of the blind spot area BA decreases.

Further, the action plan generator 123 may determine the target rudder angle together with the target speed again to generate the new target trajectory. For example, when the object OB that is being tracked has entered the blind spot area BA and has been lost, the action plan generator 123 may determine the target rudder angle so that the host vehicle M travels to the side on which the object OB has not been lost, in other words, so that the host vehicle M moves away in the vehicle width direction from the object OB present in the blind spot area BA.

The travel controller 141 performs the speed control or performs the steering control in addition to the speed control, by referring to the target trajectory newly generated by the action plan generator 123 when the starting condition of lane change has been satisfied (step S116).

Thus, the travel controller 141 performs the acceleration control or the deceleration control or performs the steering control in addition thereto, thereby changing the relative position of the host vehicle M with respect to the object OB present in the blind spot area BA. Accordingly, the object OB present in the blind spot area BA and not recognized is recognized again.

Then, the lane change possibility determiner 123a determines whether or not the lane change execution condition is satisfied, to determines whether or not lane change is executable (step S118).

For example, the lane change possibility determiner 123a determines that the lane change is possible when conditions (1) the outside world recognizer 121 or the host vehicle position recognizer 122 recognizes lane demarcation lines that partition a host lane on which the host vehicle M travels or an adjacent lane adjacent to the host lane, (2) various index values such as a relative distance or a relative speed between an object OB recognized again due to a change in a relative position of the host vehicle M or an object OB around the host vehicle M, including, for example, a vehicle present in an adjacent lane, which is a lane change destination, and the host vehicle, and a time to collision (TTC) obtained by dividing the relative distance by the relative speed are greater than a predetermined threshold value, and (3) a curvature or gradient of a route is in a predetermined range, which are examples of the lane change execution conditions, are all satisfied, and determines that the lane change is not possible when any of the conditions are not satisfied.

In a case in which the object OB that may be present in the blind spot area BA is not recognized again as a result of accelerating or decelerating the host vehicle M in a situation in which a nearby vehicle or the like is not recognized around the host vehicle M, the lane change possibility determiner 123a may determine that the lane change is possible when the condition (1) or (3) is satisfied.

The lane change possibility determiner 123a permits lane change control of the travel controller 141 when the lane change possibility determiner 123a determines that the lane change is possible (step S120), and prohibits the lane change control of the travel controller 141 when the lane change possibility determiner 123a determines that the lane change is not possible (step S122). The lane change control means the travel controller 141 performing the speed control and steering control on the basis of the target trajectory for lane change generated by the action plan generator 123, thereby causing the host vehicle M to perform lane change to an adjacent lane. Accordingly, the process of this flowchart ends.

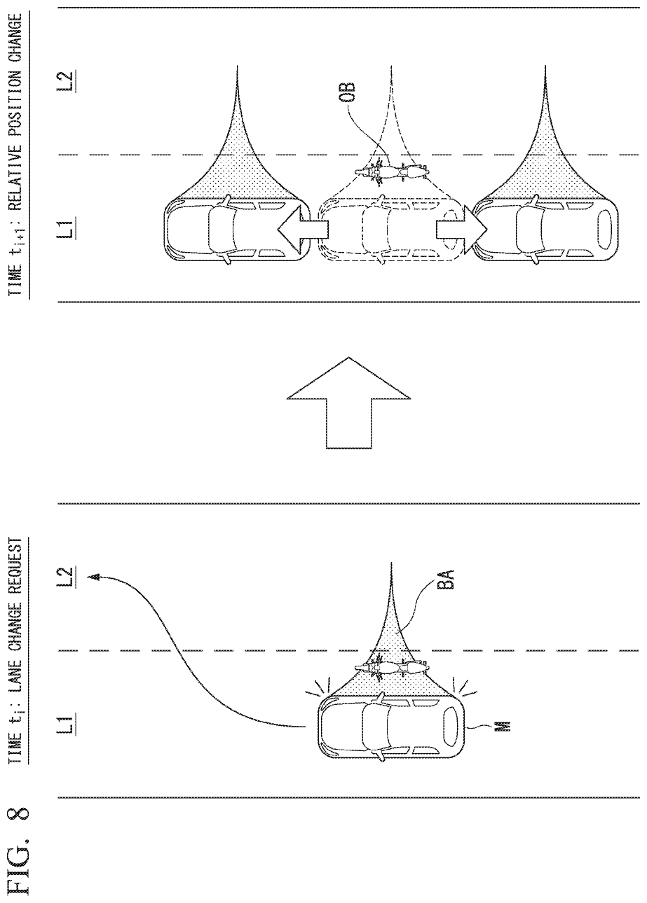

FIG. 8 is a diagram schematically showing a state in which the relative position of the host vehicle M with respect to the object OB present in the blind spot area BA is changed. A scene at time tᵢ in FIG. 8 indicates a situation when the starting condition of lane change has been satisfied. In such a scene, for example, when the blind spot area determiner 121a had determined that the object OB is present in the blind spot area BA, the travel controller 141 accelerates or decelerates the host vehicle M as in the scene shown at time thereby changing the relative position of the host vehicle M with respect to the object OB. Accordingly, the object OB is recognized again, and a determination is made as to whether or not the lane change is executable.

According to the first embodiment described above, when the blind spot area determiner has determined that the object OB is present in the blind spot area BA, the travel controller 141 performs the control for changing the relative position of the host vehicle M with respect to the object OB in the blind spot area BA, thereby changing the relative position of the host vehicle M with respect to the object OB even when the object OB is present in the blind spot area BA, such that an area that has been the blind spot area BA can be set as the detection area. As a result, it is possible to improve a degree of freedom in vehicle control by increasing the object detection performance.

Further, according to the first embodiment described above, it is possible to change the relative position of the host vehicle M with respect to the object OB that may be present in the blind spot area BA by accelerating or decelerating the host vehicle M, and it is possible to move the object OB away from the blind spot area BA when the object OB is moving at a constant speed. As a result, it is possible to detect the object OB around the host vehicle M with high accuracy.

Further, according to the first embodiment described above, it is possible to check the presence or absence of the object OB of which tracking has been interrupted and then perform the change lane, by determining whether or not the lane change is possible after accelerating or decelerating the host vehicle M. For example, when an area that has been the blind spot area BA becomes the detection area and the lost object OB has been recognized again, it is possible to determine whether or not the lane change is possible on the basis of an object OB around the host vehicle M, including the object OB. As a result, it is possible to perform the lane change with higher accuracy.

Further, according to the first embodiment described above, when the object OB is present in the blind spot area BA and the starting condition of lane change has been satisfied, the host vehicle M is accelerated or decelerated. Therefore, the acceleration control or the deceleration control is not performed in a situation in which it is not necessary to start the lane change even when the object OB is present in the blind spot area BA. Accordingly, since the speed control for changing the relative position of the host vehicle M with respect to the object OB in the blind spot area BA is not unnecessarily performed, it is possible to reduce a sense of discomfort for occupants due to change in vehicle behavior with the change in the relative position of the host vehicle M.

Further, according to the first embodiment described above, since the acceleration control or the deceleration control is performed on the condition that the object OB is not recognized again over a predetermined time or more since the temporarily tracked object OB is lost, changing the position of the host vehicle M each time the object OB enters the blind spot area BA is not performed, and it is possible to further reduce a sense of discomfort for the occupants.

Further, according to the first embodiment described above, since the acceleration control or the deceleration control is performed to change the relative position of the host vehicle M with respect to the object OB in the blind spot area BA only when the starting condition of lane change has been satisfied, it is not necessary to perform a unnecessary determination process and speed control for changing the relative position at an event with no lane change such as lane keeping. As a result, it is possible to reduce a sense of discomfort for the occupants, which may be caused by a change in vehicle behavior with the change in the relative position of the host vehicle M.

### Modification Examples of First Embodiment

Hereinafter, a modification example of the first embodiment will be described. In the first embodiment described above, a case in which, when the object OB is present in the blind spot area BA and the starting condition of lane change has been satisfied, the action plan generator 123 newly generates the target trajectory for acceleration or deceleration, thereby changing the relative position between the host vehicle M and the object OB has been described, but the present invention is not limited thereto. For example, in the modification example of the first embodiment, the action plan generator 123 newly generates the target trajectory for acceleration or deceleration when the object OB is present in the blind spot area BA, regardless of whether or not the starting condition of lane change has been satisfied, thereby changing the relative position between the host vehicle M and the object OB. Accordingly, it is possible to prevent the object OB that may be present in the blind spot area BA and the host vehicle M from traveling in parallel, for example, when lane keeping on a straight road is simply performed. As a result, it is possible to perform an instant avoidance action in which a lane is temporarily changed to an adjacent lane, for example, when there is a fallen object on a road.

Further, in the first embodiment described above, a case in which the determination is made as to whether or not the tracked object OB has entered the blind spot area BA prior to a process of the determination as to whether or not the starting condition of lane change has been satisfied has been described, but the present invention is not limited thereto. For example, in the modification example of the first embodiment, the determination is made as to whether or not the starting condition of lane change has been satisfied, and the determination is made as to whether or not the tracked object OB has entered the blind spot area BA when the starting condition of lane change has been satisfied.

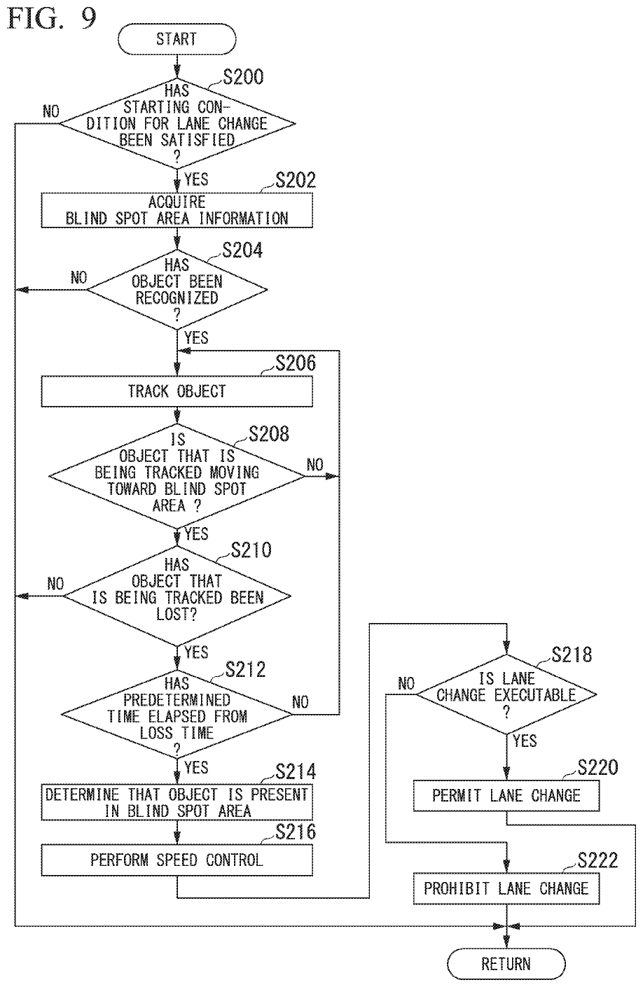

FIG. 9 is a flowchart showing another example of the series of processes of the object recognition device 16 and the automated driving controller 100 in the first embodiment. The process of the flowchart may be performed repeatedly at predetermined time intervals, for example.

First, the lane change possibility determiner 123a determines whether or not the starting condition of lane change has been satisfied by referring to the action plan generated by the action plan generator 123 (step S200). When the starting condition of lane change is not satisfied, that is, when the event with lane change is not scheduled in the action plan, when the event with lane change is scheduled, but the host vehicle M has not reached the point at which the event has been scheduled, or when the winker has not been operated, the process of the flowchart ends.

On the other hand, when the starting condition of lane change has been satisfied, that is, when the host vehicle M has reached the point at which an event with lane change has been scheduled, or when the winker has been operated, the blind spot area determiner 121a acquires the blind spot area information D1 from the storage 160 (step S202).

Then, the tracking processor 16b determines whether or not the object OB has been recognized by the sensor fusion processor 16a (step S204). When the object OB has not been recognized, the process of the flowchart ends.

On the other hand, when the object OB has been recognized, the tracking processor 16b determines whether or not the object is the same as the object OB recognized in the past by the sensor fusion processor 16a, and tracks the object OB when the object is the same as the object OB recognized by the sensor fusion processor 16a (step S206).

Then, the blind spot area determiner 121a determines whether or not the object OB tracked by the tracking processor 16b is moving toward the blind spot area BA by referring to information output by the tracking processor 16b (step S208).

When the blind spot area determiner 121a has determined that the object OB is not moving toward the blind spot area BA, the blind spot area determiner 121a proceeds to S206.

On the other hand, when the blind spot area determiner 121a has determined that the object OB is moving toward the blind spot area BA, the blind spot area determiner 121a determines whether or not the object OB tracked by the tracking processor 16b has been lost (no longer recognized) (step S210). When the tracked object OB is not lost, the process of the flowchart ends.

On the other hand, when the tracked object OB has been lost, the blind spot area determiner 121a determines whether or not a predetermined time has elapsed from a loss time t, (step S212). When the predetermined time has not elapsed, the process proceeds to S206 in which the blind spot area determiner 121a determines whether or not the object OB recognized before loss has been recognized again, that is, whether or not tracking has been resumed.

On the other hand, when the tracking processor 16b does not resume tracking before the predetermined time elapses from the loss time tᵢ, the blind spot area determiner 121a determines that the object OB recognized before loss enters the blind spot area BA and is still present in the blind spot area BA at a point in time when the predetermined time has elapsed (step S214).

Then, the action plan generator 123 newly generates a target trajectory for changing the relative position of the host vehicle M with respect to the object OB present in the blind spot area BA. Then, the travel controller 141 performs the acceleration control or the deceleration control on the basis of the target trajectory newly generated by the action plan generator 123 (step S216).

Then, the lane change possibility determiner 123a determines whether or not the lane change execution condition is satisfied, to determines whether or not the lane change is executable (step S218).

The lane change possibility determiner 123a permits lane change control of the travel controller 141 when the lane change possibility determiner 123a determines that the lane change is possible (step S220), and prohibits the lane change control of the travel controller 141 when the lane change possibility determiner 123a determines that the lane change is not possible (step S222). Accordingly, the process of this flowchart ends.

As described above, the determination is made as to whether or not the tracked object OB has entered the blind spot area BA only when there is a point at which an event with lane change such as a branching event has been scheduled in the route determined by the route determiner 53 of the navigation device 50 or when the winker has been operated by the occupant. Accordingly, it is not necessary to perform an unnecessary determination process and position change control on the object OB when there is no point at which the event without lane change such as lane keeping has been scheduled or when the winker has not been operated. As a result, it is possible to reduce a processing load of the vehicle control system 1 and to reduce a sense of discomfort for occupants due to change in vehicle behavior with the change in the relative position of the host vehicle M.

### Second Embodiment

Hereinafter, a second embodiment will be described. In the first embodiment described above, a case in which, when the object OB has entered the blind spot area BA, the acceleration control or the deceleration control is performed so that the relative position of the host vehicle M with respect to the object OB is changed, the position of the blind spot area BA is shifted, and the object OB is recognized again has been described. The second embodiment is different from the first embodiment described above in that, when the object OB is not recognized again as a result of performing the acceleration control or the deceleration control in a case in which the object OB has entered the blind spot area BA, the occupant is requested to monitor the surroundings. Hereinafter, differences from the first embodiment will be described mainly, and descriptions of functions or the like that are the same as in the first embodiment will be omitted.

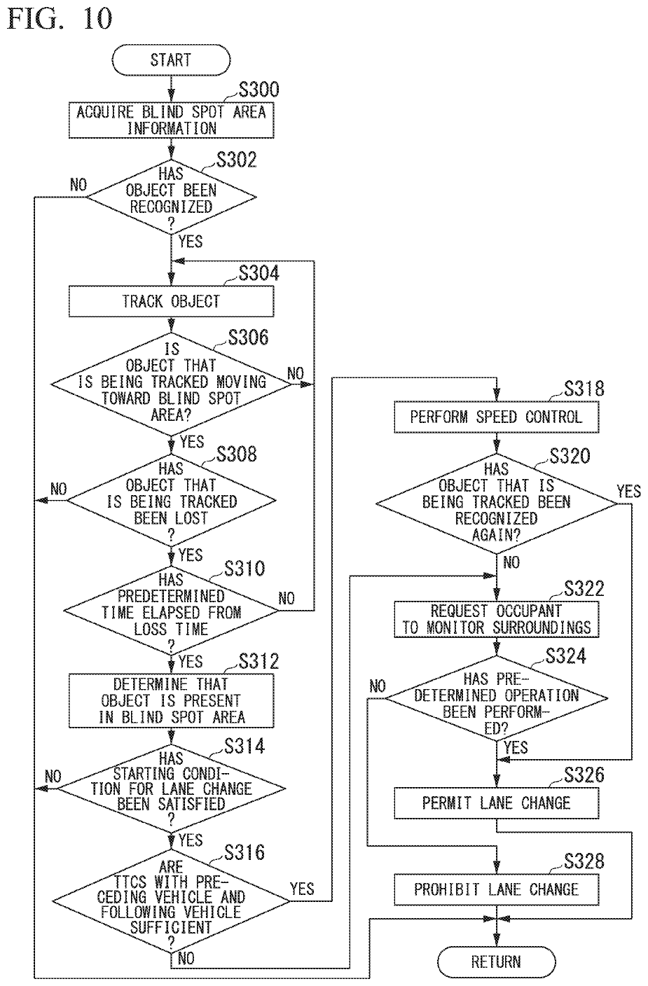

FIG. 10 is a flowchart showing an example of a series of processes that are performed by the object recognition device 16 and the automated driving controller 100 according to the second embodiment. The process of the flowchart may be performed repeatedly at predetermined time intervals, for example.

First, the blind spot area determiner 121a acquires the blind spot area information D1 from the storage 160 (step S300).

Then, the tracking processor 16b determines whether or not the object OB has been recognized by the sensor fusion processor 16a (step S302). When the object OB has not been recognized by the sensor fusion processor 16a, the process of the flowchart ends.

On the other hand, when the object OB has been recognized by the sensor fusion processor 16a, the tracking processor 16b determines whether or not the object is the same as the object OB recognized in the past by the sensor fusion processor 16a, and tracks the object OB when the object is the same as the object OB recognized by the sensor fusion processor 16a (step S304).

Then, the blind spot area determiner 121a determines whether or not the object OB tracked by the tracking processor 16b is moving toward the blind spot area BA by referring to information output by the tracking processor 16b (step S306).

When the blind spot area determiner 121a has determined that the object OB is not moving toward the blind spot area BA, the blind spot area determiner 121a proceeds to S304.

On the other hand, when the blind spot area determiner 121a has determined that the object OB is moving toward the blind spot area BA, the blind spot area determiner 121a determines whether or not the object OB tracked by the tracking processor 16b has been lost (no longer recognized) (step S308). When the tracked object OB has not been lost, the process of the flowchart ends.

On the other hand, when the tracked object OB has been lost, the blind spot area determiner 121a determines whether or not a predetermined time has elapsed from a loss time t, (step S310). When the predetermined time has not elapsed, the process proceeds to S304 in which the blind spot area determiner 121a determines whether or not the object OB recognized before loss has been recognized again, that is, whether or not tracking has been resumed.

On the other hand, when the tracking processor 16b does not resume tracking before the predetermined time elapses from the loss time tᵢ, the blind spot area determiner 121a determines that the object OB recognized before loss enters the blind spot area BA and is still present in the blind spot area BA at a point in time when the predetermined time has elapsed (step S312).

Then, the lane change possibility determiner 123a determines whether or not the starting condition of lane change has been satisfied by referring to the action plan generated by the action plan generator 123 (step S314). When the starting condition of lane change is not satisfied, that is, when the event with lane change is not scheduled in the action plan, when the event with lane change is scheduled, but the host vehicle M has not reached the point at which the event has been scheduled, or when the winker has not been operated, the process of the flowchart ends.

On the other hand, when the starting condition of lane change has been satisfied, that is, when the host vehicle M has reached the point at which the event with lane change has been scheduled, or when the winker has been operated, the travel controller 141 determines whether or not a time to collision TTC_{f} with a preceding vehicle present in front of the host vehicle M and a time to collision TTC_{b} with a following vehicle present behind the host vehicle M are equal to or greater than a threshold value (step S316). The time to collision TTC_{f} is a time obtained by dividing a relative distance between the host vehicle M and the preceding vehicle by a relative speed between the host vehicle M and the preceding vehicle, and the time to collision TTC_{b} is a time obtained by dividing a relative distance between the host vehicle M and the following vehicle by a relative speed between the host vehicle M and the following vehicle.

When the time to collision TTC_{f} of the host vehicle M and the preceding vehicle and the time to collision TTC_{b} of the host vehicle M and the following vehicle are both smaller than the threshold values, the travel controller 141 proceeds to S322 to be described below since a sufficient inter-vehicle distance for accelerating or decelerating the host vehicle M to shift the position of the blind spot area BA cannot be maintained.

On the other hand, when one or both of the time to collision TTC_{f} of the host vehicle M and the preceding vehicle or the time to collision TTC_{b} of the host vehicle M and the following vehicle is equal to or greater than the threshold value, the action plan generator 123 newly generates a target trajectory for changing the relative position of the host vehicle M with respect to the object OB present in the blind spot area BA. Then, the travel controller 141 performs the acceleration control or the deceleration control on the basis of the target trajectory newly generated by the action plan generator 123 (step S318).

For example, when the time to collision TTC_{f} of the host vehicle M and the preceding vehicle is equal to or greater than the threshold value and the time to collision TTC_{b} of the host vehicle M and the following vehicle is smaller than the threshold value, the action plan generator 123 generates a target trajectory having a higher target speed for acceleration since a sufficient inter-vehicle distance is present in front of the vehicle.

Then, the blind spot area determiner 121a determines whether or not the object OB lost during tracking has been recognized again by the tracking processor 16b as a result of the acceleration control or the deceleration control of the travel controller 141 (step S320).

When the object OB lost during tracking has been recognized again by the tracking processor 16b, the travel controller 141 proceeds to a process of 5326 to be described below.

On the other hand, when the object OB lost during tracking is not recognized again by the tracking processor 16b, the blind spot area determiner 121a causes the display device of the HMI 30 or the like to output information for prompting checking of whether or not the object OB is present around the host vehicle M, thereby requesting the occupant to monitor the surroundings (particularly, monitor the blind spot area BA) (step S322).

For example, when the object OB that is being tracked on the right side in the traveling direction of the host vehicle M is lost, the blind spot area determiner 121a may cause the HMI 30 to output information for prompting mainly checking of the right side in the traveling direction.

Then, the blind spot area determiner 121a determines, for example, whether or not a predetermined operation has been performed with respect to the touch panel of the HMI 30 or the like within a predetermined time by an occupant who has been requested to monitor the surroundings (step S324). Further, the blind spot area determiner 121a may determine that the predetermined operation has been performed when the winker lever of the driving operator 80 or the like has been operated after the monitoring of the surroundings has been requested.

When the predetermined operation has been performed within the predetermined time, the lane change possibility determiner 123a determines that the object OB is not present in the blind spot area BA, and permits the lane change control of the travel controller 141 (step S326).

On the other hand, when the predetermined operation has not been performed within the predetermined time, it is uncertain whether or not the object OB is present in the blind spot area BA. Accordingly, the lane change possibility determiner 123a prohibits the lane change control of the travel controller 141 (step S328). Accordingly, the process of this flowchart ends.

According to the second embodiment described above, when the object OB is not recognized again as a result of performing acceleration control or deceleration control when the object OB has entered the blind spot area BA, the occupant is requested to monitor the surroundings and lane change is performed. Therefore, it is possible to perform lane change with higher accuracy.

### Third Embodiment

Hereinafter, a third embodiment will be described. A vehicle control system 2 according to the third embodiment is different from the first and second embodiments described above in that the vehicle control system 2 performs control for assisting in manual driving when speed control and steering control are performed according to an operation of an occupant with respect to the driving operator 80, that is, when manual driving is performed. Hereinafter, differences from the first and second embodiments will be described mainly, and descriptions of functions or the like that is the same as in the first and second embodiments will be omitted.

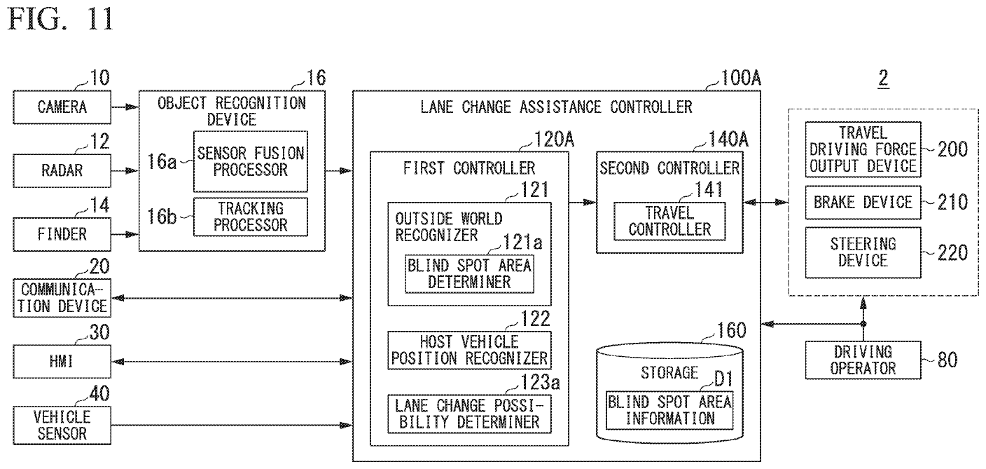

FIG. 11 is a configuration diagram of the vehicle control system 2 of the third embodiment. The vehicle control system 2 of the third embodiment includes, for example, a camera 10, a radar 12, a finder 14, an object recognition device 16, a communication device 20, an HMI 30, a vehicle sensor 40, a driving operator 80, a lane change assistance controller 100A, a travel driving force output device 200, a brake device 210, and a steering device 220. These devices or equipment are connected to each other by a multiple communication line such as a CAN communication line, a serial communication line, a wireless communication network, or the like. The configuration shown in FIG. 11 is merely an example, and a part of the configuration may be omitted, or another configuration may be added.

The lane change assistance controller 100A includes, for example, a first controller 120A, a second controller 140A, and a storage 160. The first controller 120A includes the outside world recognizer 121, the host vehicle position recognizer 122, and the lane change possibility determiner 123a that is one function of the action plan generator 123 described above. The second controller 140A includes a travel controller 141. A combination of the lane change possibility determiner 123a and the travel controller 141 in the third embodiment is another example of a “lane change controller”.

For example, the lane change possibility determiner 123a determines that the starting condition of lane change has been satisfied when the operation detector of the driving operator 80 has detected that the position of the winker lever has been changed, that is, when the lane change is instructed by an intention of an occupant.

Then, the blind spot area determiner 121a determines whether or not the object OB tracked by the tracking processor 16b of the object recognition device 16 has been lost (no longer recognized). It is assumed that the tracking processor 16b repeatedly performs a tracking process at predetermined cycles regardless of whether or not the winker lever has been operated by the occupant.

When the tracked object OB has been lost, the blind spot area determiner 121a determines whether or not a predetermined time has elapsed from a loss time tᵢ. When the predetermined time has not elapsed, the blind spot area determiner 121a determines whether or not the object OB recognized before loss has been recognized again, that is, whether or not tracking has been resumed.

When the tracking processor 16b does not resume tracking before the predetermined time elapses from the loss time tᵢ the blind spot area determiner 121a determines that the object OB recognized before loss enters the blind spot area BA and is still present in the blind spot area BA at a point in time when the predetermined time has elapsed.

When the object OB is present in the blind spot area BA, the travel controller 141 performs the acceleration control or the deceleration control. When the object OB lost during tracking has been recognized again by the tracking processor 16b as a result of the acceleration control or the deceleration control, the travel controller 141 performs lane change assistance control according to an operation of the winker lever. The lane change assistance control is, for example, to assist in steering control so that the host vehicle M smoothly changes the lane from the host lane to the adjacent lane.

According to the third embodiment described above, when the starting condition of lane change has been satisfied due to the operation of the winker lever, a determination is made as to whether or not the object OB is present in the blind spot area BA, and the host vehicle M is accelerated or decelerated when the object OB is present in the blind spot area BA. Therefore, it is possible to detect the object OB around the host vehicle M with high accuracy. As a result, it is possible to perform lane change assistance control with higher accuracy.

The forms for implementing the present invention have been described using the embodiments, but the present invention is not limited to such embodiments at all, and various modifications and substitutions can be made without departing from the gist of the present invention. For example, “determine whether or not the object detected by the detector is present in a blind spot area, the blind spot area being outside the detection area of the detector” in the claims also includes to determine that an object OB such as a two-wheeled vehicle is present in the blind spot area BA when it has been predicted that the object OB enters the blind spot area BA.

### DESCRIPTION OF REFERENCE NUMERALS

1, 2 Vehicle control system

10 Camera

12 Radar

14 Finder

16 Object recognition device

16a Sensor fusion processor

16b Tracking processor

20 Communication device

30 HMI

40 Vehicle sensor

50 Navigation device

51 GNSS receiver

52 Navigation HMI

53 Route determiner

54 First map information

60 MPU

61 Recommended lane determiner

62 Second map information

80 Driving operator

100 Automated driving controller

100A Lane change assistance controller

120, 120A First controller

121 Outside world recognizer

121a Blind area determiner

122 Host vehicle position recognizer

123 Action plan generator

123a Lane change possibility determiner

140, 140A Second controller

141 Travel controller

142 Switching controller

16 Storage

D1 Blind area information

200 Travel driving force outputter

210 Brake device

220 Steering device

1. A vehicle control system comprising:
a detector configured to detect an object present in a detection area;
a travel controller configured to perform travel control for a host vehicle on the basis of a detection result of the detector; and
a determiner configured to determine whether or not the object detected by the detector is present in a blind spot area, the blind spot area being outside the detection area of the detector,
wherein the travel controller is configured to perform control for changing a relative position of the host vehicle with respect to the object in the blind spot area when the determiner has determined that the object is present in the blind spot area.

2. The vehicle control system according to claim 1, wherein the travel controller is configured to perform control for changing the relative position of the host vehicle with respect to the object in the blind spot area through speed control when the determiner has determined that the object is present in the blind spot area.

3. The vehicle control system according to claim 1,
wherein the blind spot area is present on the side of the host vehicle, and
the travel controller is configured to change the relative position of the host vehicle with respect to the object in the blind spot area according to a width of the blind spot area in a traveling direction of the host vehicle.

4. The vehicle control system according to claim 1, further comprising:
a lane change controller configured to automatically perform lane change from a host lane to an adjacent lane,
wherein the lane change controller is configured to determine whether or not the host vehicle is capable of lane change from the host lane to the adjacent lane after the travel controller has changed the relative position of the host vehicle with respect to the object in the blind spot area in a case in which a starting condition of the lane change has been satisfied and the determiner has determined that the object is present in the blind spot area.

5. The vehicle control system according to claim 4, wherein when the determiner has determined that the object is present in the blind spot area and the starting condition of lane change in the lane change controller has been satisfied, the travel controller is configured to perform control for changing the relative position of the host vehicle with respect to the object in the blind spot area through speed control.

6. The vehicle control system according to claim 1, further comprising:
a lane change controller configured to automatically perform lane change from a host lane to an adjacent lane,
wherein the determiner is configured to determine whether or not the object detected by the detector is present in the blind spot area when the starting condition of lane change in the lane change controller has been satisfied.

7. The vehicle control system according to claim 6, further comprising:
a route determiner configured to determine a route for travel of the vehicle,
wherein the starting condition of lane change include lane change from the host lane to the adjacent lane being scheduled in the route determined by the route determiner.

8. The vehicle control system according to claim 1, wherein the determiner is configured to determine that an object is present in the blind spot area when the object temporarily detected by the detector is not continuously detected over a predetermined time or more.

9. A vehicle control system comprising:
a detector configured to detect an object present in a detection area;
a generator configured to generate an action plan for the host vehicle;
a travel controller configured to perform travel control of the host vehicle on the basis of a detection result of the detector and the action plan generated by the generator; and
a determiner configured to determine whether or not the object detected by the detector is present in a blind spot area, the blind spot area being outside the detection area of the detector,
wherein the generator is configured to generate, as the action plan, a plan for changing a relative position of the host vehicle with respect to the object in the blind spot area when the determiner has determined that the object is present in the blind spot area.

10. A vehicle control system comprising:
a detector configured to detect an object present in a detection area;
a travel controller configured to perform travel control for a host vehicle on the basis of a detection result of the detector; and
a determiner configured to determine whether or not the object detected by the detector is present in a blind spot area, the blind spot area being outside the detection area of the detector,
wherein the travel controller is configured to perform control for changing a relative position of the host vehicle with respect to the object in the blind spot area when the object is not detected in the detection area of the detector within a predetermined time after the determiner is configured to determine that the object is present in the blind spot area.

11. A vehicle control method comprising:
detecting, by an in-vehicle computer, an object present in a detection area;
performing, by the in-vehicle computer, travel control for a host vehicle on the basis of a detection result for the object;
determining, by the in-vehicle computer, whether or not the detected object is present in a blind spot area, the blind spot area being outside the detection area; and
performing, by the in-vehicle computer, control for changing a relative position of the host vehicle with respect to the object in the blind spot area when it is determined that the object is present in the blind spot area.

12. The vehicle control method according to claim 11, comprising:
automatically performing, by the in-vehicle computer, lane change from a host lane to an adjacent lane; and
determining, by the in-vehicle computer, whether or not the detected object is present in the blind spot area when a starting condition of the lane change has been satisfied.

13. A vehicle control method comprising:
detecting, by an in-vehicle computer, an object present in a detection area;
performing, by the in-vehicle computer, travel control for a host vehicle on the basis of a detection result for the object;
determining, by the in-vehicle computer, whether or not the detected object is present in a blind spot area, the blind spot area being outside the detection area; and
performing, by the in-vehicle computer, control for changing a relative position of the host vehicle with respect to the object in the blind spot area when the object is not detected in the detection area within a predetermined time after it is determined that the object is present in the blind spot area.
